(19) United States
(12) Patent Application Publication
(10) Pub. No.: US 2026/0132675 A1
(43) Pub. Date: May 14, 2026

(54) CELLULAR BLIND WITH INTERCHANGEABLE FABRIC

(71) Applicant: Dreamaker Global Limited, Douglas (GB)

(72) Inventors: Cormac Donal Diamond, Bellaghy (GB); Molly Elizabeth Turbitt, Ballyclare (GB); Colm Patrick Kerr, Belfast (GB)

(21) Appl. No.: 19/373,237

(22) Filed: Oct. 29, 2025

(30) Foreign Application Priority Data
Nov. 11, 2024 (GB) 2416211.7

(51) Int. Cl. E06B 9/388; E06B 9/262; E06B 9/322

(52) U.S. Cl. CPC E06B 9/388; E06B 9/262; E06B 9/322; E06B 2009/2627

(57) ABSTRACT

A cellular blind includes a headrail, a bottom rail, one or more lengths of cellular fabric between the headrail and bottom rail, and control cords extending through at least one of the length(s) of cellular fabric and terminating in or adjacent the bottom rail or, optionally, in or adjacent an intermediate rail suspended from the head rail. The cords can be raised or lowered via a control mechanism in the headrail to rail or lower the blind. An upper end of the or each length of cellular fabric is detachably secured respectively to the headrail or intermediate rail, to permit replacement of the length(s) of cellular fabric. Each cord terminates in a toggle for preventing removal of the cords from the length(s) of cellular fabric when in a first configuration, while permitting removal of the cords from the fabric when in a second configuration.

### CROSS REFERENCE TO RELATED APPLICATION

The present application claims priority benefit of U.K. Pat. Application Ser. No. 2416211.7 filed Nov. 11, 2024, which is hereby incorporated herein by reference in its entirety.

### FIELD

This disclosure relates to an improved cellular blind and in particular to an improved cellular blind with user/customer interchangeable fabric.

### BACKGROUND

Cellular or “honeycomb” blinds are becoming increasingly popular due to their advantageous thermal insulation properties and attractive aesthetics. The blind fabric comprises a stack of tubular pleated cells, each defining an air pocket which provide excellent insulation, helping to keep a home cool during hot summer days and warm during the cold winter months.

The blind fabric can be retracted or drawn into a contracted state, wherein the cells collapse into a stack. Control cords, typically one adjacent each side of the blind, extend through the fabric from top to bottom and are secured to a bottom rail at a bottom end of the fabric. The cords are typically wound around a roller in a headrail at a top end of the blind whereby the roller can be rotated to raise and lower the blind. The top end of the fabric may be attached to the headrail, or to an intermediate rail suspended from the head rail and adapted to be raised and lowered with respect to the headrail in the case of a “top down” opening blind, or may be lowered from the intermediate bar as well as raised from the bottom rail in a top down bottom up configuration.

Over time, the fabric of a cellular blind may become dirty, faded or damaged or it may be desired simply to change the appearance or colour of the fabric, for example when a room is redecorated.

Due to the presence of the control cords extending through the fabric, changing the fabric, particularly in situ, is problematic. Furthermore, detachment of the fabric from the headrail or intermediate rail is not normally possible without removing the entire blind from the window opening. Therefore, any desire to change the fabric on the part of the customer usually requires costly replacement of the entire cellular blind assembly.

### SUMMARY

According to a first aspect there is provided a cellular blind comprising a headrail, a bottom rail, and one or more lengths of cellular fabric located between the headrail and the bottom rail, a plurality of control cords extending through the cellular fabric and terminating in or adjacent the bottom rail or, where provided, an intermediate rail between the headrail and bottom rail, whereby the cords can be raised or lowered via a control mechanism in the headrail to rail or lower the blind, wherein an upper end of the cellular fabric is detachably secured to the headrail, or an intermediate rail suspended from the head rail, to permit replacement of the cellular fabric and wherein each cord terminates in a toggle adapted to prevent removal of the cords from the fabric when in a first configuration while permitting removal of the cords from the fabric when in a second configuration.

In one embodiment, each toggle is moveable between the first configuration, wherein the toggle extends substantially perpendicular to the respective cord to operatively retain the cords within the cellular fabric and allow operation of the blind, and the second configuration, wherein the toggle is axially aligned with the respective cord whereby the toggles can be pushed through the cellular fabric to thread the cords through the fabric or remove the cords from the fabric to facilitate replacement of the cellular fabric.

The cords may extend from each toggle at a point between the distal ends of each toggle when the toggles are in their first configuration. In one embodiment the cords may extend from a central region of each toggle when the toggles are in their first configuration.

An upper end of the or each length of cellular fabric may be attached to the headrail, or to the intermediate rail, by a releasable fastening mechanism permitting detachment of the length of cellular fabric therefrom in a downwards direction, perpendicular to the head rail or intermediate rail respectively. The releasable fastening mechanism may comprise one or more magnetic fasteners.

The cellular fabric may be detachably secured to the bottom rail or intermediate rail at a lower end, the rail incorporating a channel in an upper face thereof, the channel receiving a bottom portion of the cellular fabric, whereby the rail can be slid on and off the bottom portion of the cellular fabric in a transverse direction to detach and attach the rail to the cellular fabric, and wherein the channel includes a recess for housing the toggles when in their first configuration to retain the toggles in the first configuration when the rail is attached to the cellular fabric. The bottom portion of the cellular fabric received in the channel may comprise or incorporate a reinforced strip adapted to be received and retained in the channel.

Optionally, the cords are wrapped around a roller within headrail, whereby rotation of the roller raises and lowers the lower end of the blind. The roller may be rotatable by means of an electric motor, for example.

In one embodiment each toggle may comprise an elongate tubular body through which a respect cord is inserted, a distal end of the cord being knotted or having a fitting attached thereto to prevent removal of the respective cord from the toggle once inserted therein. Each toggle may have a slot extending along a portion of its length from a first end thereof, the slot terminating at a location between the first end and a midpoint of the toggle, the distal end of the respective cord extending through a second end of the toggle, opposite the first end, wherein the cord rests in the slot when the toggle is in its second configuration and moves out of the slot to extend perpendicular to the body of the toggle when the toggle is in its first configuration.

According to a further aspect there is provided a cellular blind comprising a headrail, a bottom rail, and one or more lengths of cellular fabric located between the headrail and the bottom rail, a plurality of control cords extending from the headrail, through at least one or the one or more lengths of cellular fabric and terminating in or adjacent a lower end of the at least one or the one or more lengths of cellular fabric, whereby the cords can be raised or lowered via a control mechanism in the headrail to rail or lower the blind, wherein an upper end of the at least one or the one or more lengths of cellular fabric cellular fabric is detachably secured to the headrail, or to an intermediate rail suspended from the head rail by a releasable fastening mechanism permitting detachment of the length of cellular fabric therefrom in a downwards direction, perpendicular to the respective rail.

The releasable fastening mechanism may comprise one or more magnetic fasteners.

In one embodiment each cord may terminate in a toggle, each toggle being moveable between a first configuration, wherein the toggle extends substantially perpendicular to the respective cord to operatively retain the cords within the cellular fabric and allow operation of the blind, and a second configuration, wherein the toggle is axially aligned with the respective cord whereby the toggles can be pushed through the cellular fabric to thread the cords through the fabric or remove the cords from the fabric to facilitate replacement of the cellular fabric.

These and other objects, advantages, purposes and features of the present disclosure will become apparent upon review of the following specification in conjunction with the drawings.

### BRIEF DESCRIPTION OF THE DRAWINGS

A cellular blind in accordance with various embodiments will now be described, by way of example only, with reference to the accompanying drawings, in which:

FIG. 1 is a front view of a cellular blind in accordance with a first embodiment;

FIG. 2 is a perspective view of the cellular blind of FIG. 1 showing detachment of the fabric from the headrail;

FIG. 3 is a sectional view through the cellular blind of FIG. 1;

FIG. 4 is a perspective view of the cellular blind of FIG. 1 illustrating removal of the bottom rail from the fabric;

FIG. 5 is a perspective view of the cellular blind of FIG. 1 showing the toggles in their first configuration;

FIG. 6 is a perspective view of the cellular blind of FIG. 1 showing the toggles in their second configuration;

FIG. 7 is a perspective view of the cellular blind of FIG. 1 showing the toggles in their second configuration illustrating removal of the fabric; and

FIG. 8 is a detailed perspective view of the cellular blind of FIG. 1 illustrating the construction of the bottom rail and its attachment to the fabric;

FIG. 9 is a perspective view of a cellular blind in accordance with a second embodiment;

FIG. 10 is a front view of the cellular blind of FIG. 9;

FIG. 11 is a sectional view through the cellular blind of FIG. 9;

FIG. 12 is a perspective view of a cellular blind in accordance with a third embodiment;

FIG. 13 is a front view of the cellular blind of FIG. 12; and

FIG. 14 is a sectional view through the cellular blind of FIG. 12.

### DETAILED DESCRIPTION OF THE DRAWINGS

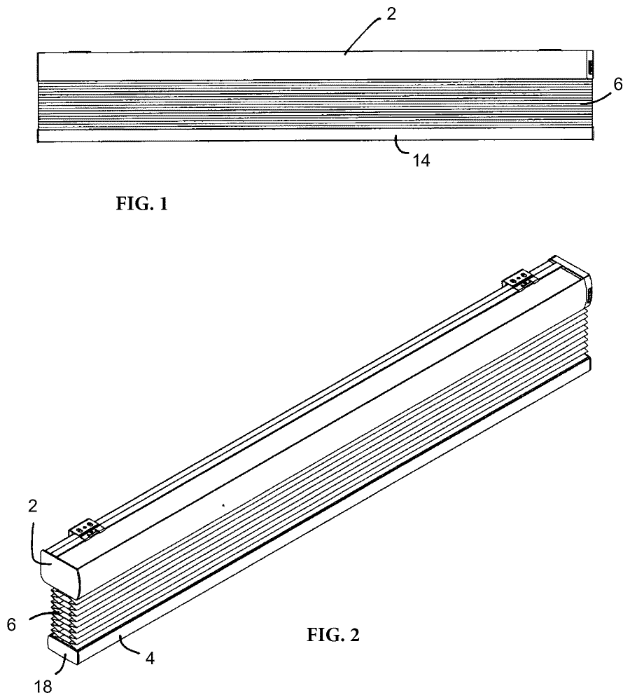

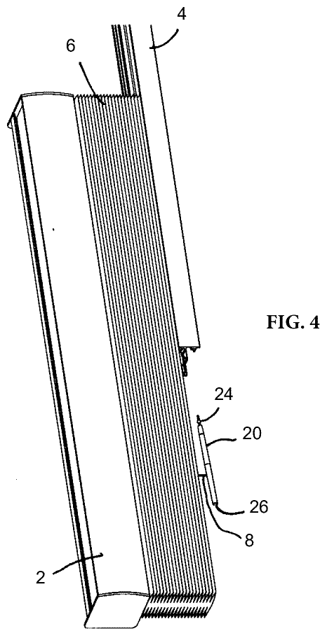

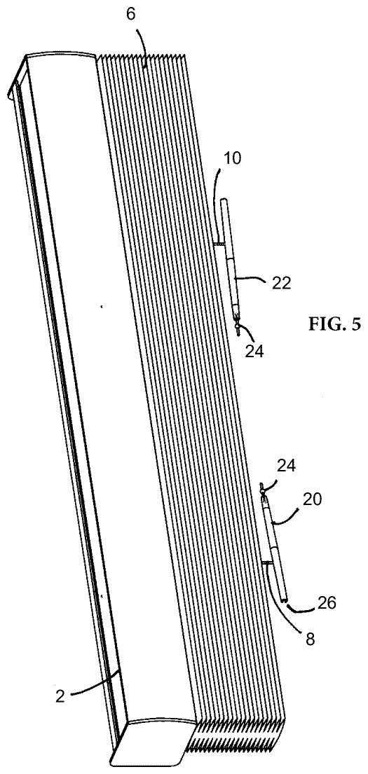

As illustrated in FIGS. 1 to 8 of the drawings, a cellular blind in accordance with a first embodiment includes a headrail 2, a bottom rail 4, and a length of cellular fabric 6 extending between the headrail 2 and the bottom rail 4. The cellular fabric 6 comprises a stack of tubular pleated cells, each defining an air pocket. The cellular fabric 6 can be retracted or drawn into a contracted state, wherein the cells collapse into a stack and extended, opening out the pleated cells to provide coverage of a window opening. Control cords 8,10, one adjacent each side of the blind, respectively extend through a series of vertically aligned apertures 15 through the fabric 6 from top to bottom. The cords 8,10 are wound around a motorised roller 9 within the headrail 2 whereby the roller 9 can be rotated to raise and lower the blind, as is known in the art and therefor need not be described in further detail.

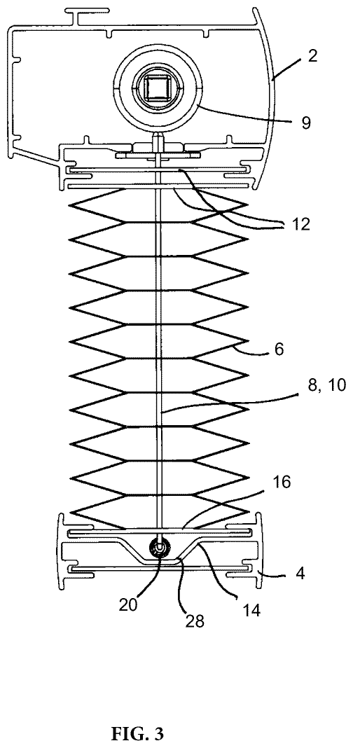

As shown in FIG. 3 the cellular fabric 6 can be attached to the headrail 2 by a releasable fastening mechanism 12 permitting detachment of the upper end of the cellular fabric 6 from the headrail 2 in a downwards direction, perpendicular to the head rail 2. In the embodiment shown, the releasable fastening mechanism 12 may comprise one or more magnetic fasteners, although other fastening mechanisms are envisaged. By permitting detachment of the upper end of the cellular fabric 6 from the headrail 2 in a downwards direction, perpendicular to the head rail 2, replacement of the cellular fabric 6 can be achieved with the headrail attached to an upper face of a window opening, allowing the fabric to be replaced in situ by the customer.

A lower end of the cellular fabric 6 can be detachably secured to the bottom rail 4. The bottom rail 4 incorporates a channel 14 in an upper face thereof, the channel 14 receiving substantially rigid strip 16 comprising or located in a lower end of the of the fabric 6, whereby the bottom rail 4 can be slid on and off the lower end of the cellular fabric 6 in a transverse direction to detach and attach the bottom rail 4 to the cellular fabric 6. Detachable end caps 18 may be attached to the ends of the bottom rail 4 once it has been slid onto the lower end of the cellular fabric 6.

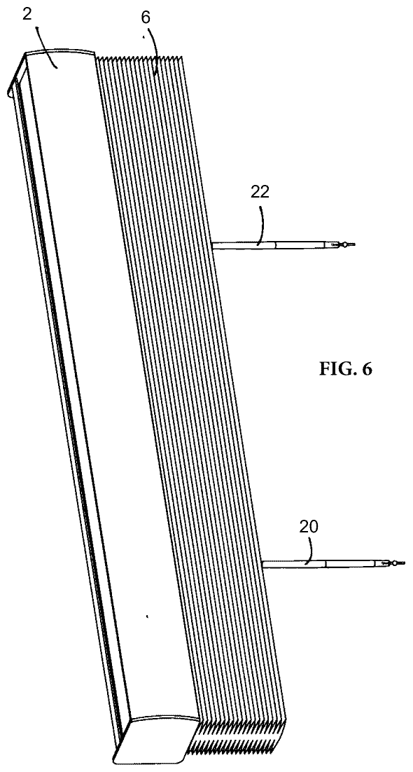

To secure distal ends of the cords 8,10 to the fabric 6 and allow the cords 8,10 to be removed from the fabric 6 when it is desired to change the fabric 6, each cord 8,10 terminates in a toggle 20,22, each toggle 20,22 being moveable between a first configuration (shown in FIG. 5), wherein the toggle 20,22 extends substantially perpendicular to the respective cord 8,10 to operatively retain the cords 8,10 within the cellular fabric 6 and allow operation of the blind, and a second configuration (as shown in FIG. 6), wherein each toggle 20,22 is axially aligned with the respective cord 8,10 whereby the toggles 20,22 can be pushed through the apertures in the cellular fabric 6 to pass the cords 8,10 through the apertures in the fabric 6 to remove or replace the cords 8,10 from the fabric to facilitate replacement of the cellular fabric 6.

As illustrated in FIG. 5, wherein in their first configuration, the toggles 20,22 engage a lower face of the lower end of the fabric 6 and prevent the cords 8,10 from being pulled though the fabric 6, allowing the fabric 6 to be supported by the cords 8,10 and enabling the blind to be raised and lowered by winding and unwinding the cords 8,10 around the roller in the headrail 2. The toggles 20,22 are adapted such that the cords 8,10 extend from a central region of the respective toggle 20,22 when the toggles are in their first configuration, as explained in more detail below.

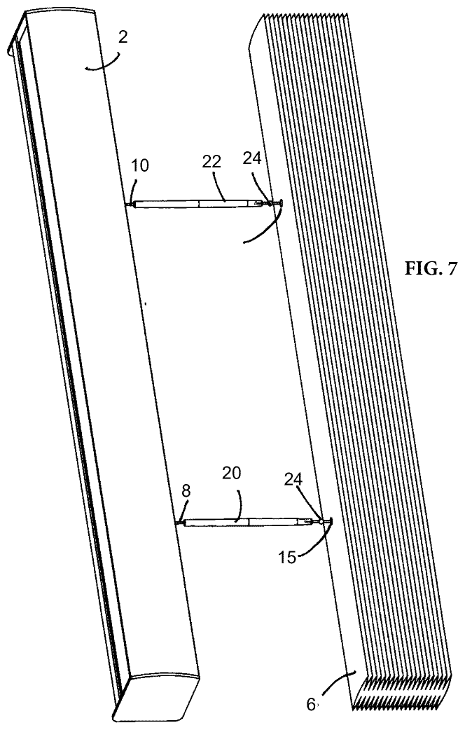

As illustrated in FIGS. 6 and 7, when in their second configuration, the toggles 20,22 can pass though the respective aligned apertures in the cellular fabric 6, allowing the cords 8,10 to be pulled through the fabric 6 and facilitate removal of the fabric 6 from the headrail 2 and allowing the toggles 20,22, and hence the cords 8,10, to be passed through the respective aligned apertures in the fabric 6 to facilitate replacement of the fabric 6.

In the embodiment shown, each toggle 20,22 comprises an elongate hollow tubular plastic body through which a respect cord 8,10 is inserted, a distal end of the cord 8,10 being knotted or having a fitting or bead 24 attached thereto to prevent removal of the respective cord 8,10 from its toggle 20,22, once inserted therethrough.

Each toggle 20,22 has a slot 26 in a side thereof, extending along a portion of its length, from a first end thereof, the slot 26 terminating at a location between the first end and a midpoint of the respective toggle 20,22, the distal end of the respective cord 8,10 extending through a second end of the respective toggle 20,22, opposite the first end. The respective cord 8,10 rests in the slot 26 of the respective toggle 20,22 when the toggle 20,22 is in its second configuration, a portion of the respective cord 8,10 moving out of the slot 26 such that the cord 8,10 extends perpendicular to the body of the toggle 20,22 when the toggle is in its first configuration.

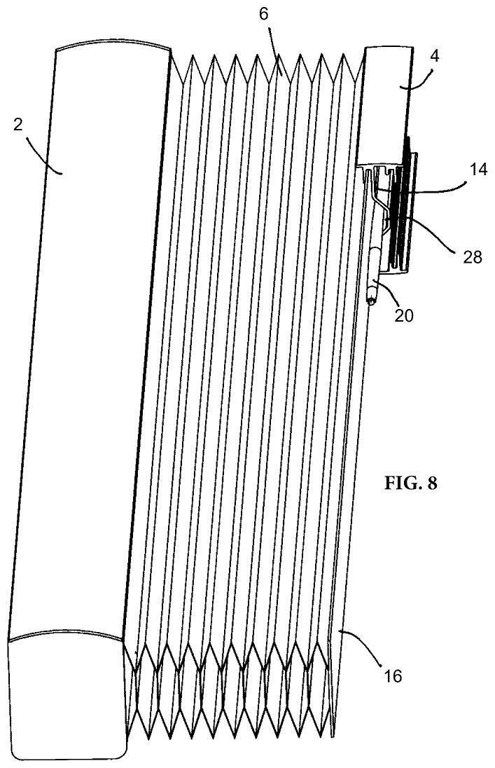

As illustrated in FIGS. 3 and 8, the channel 14 in the bottom rail 4 include a recess 28 in a base of the channel 14 for locating and housing the toggles 20,22 when in their first configuration and when the bottom rail 4 is slid onto the lower end of the fabric 6 to thereby retain each toggle 20,22 in its first configuration when the bottom rail 4 is attached to the cellular fabric 6 and thereby retain the distal ends of the cords 8,10 in operative engagement with the bottom of the fabric 6.

When it is desired to replace the fabric 6, the bottom rail 4 can be slid off the bottom end of the fabric 6, releasing the toggles 20,22 and allowing them to be manipulated to their second configuration to allow the toggles 20,22, and cords 8,10, to be removed from the fabric 6 is it is detached from the headrail 2. The toggles 20,22, and attached cords 8,10, may then be threaded through the respective aligned apertures in the replacement fabric 6, with the toggles 20,22 in their second configuration, such that the cords 8,10 pass through the fabric 6. The fabric 6 can then be attached to the headrail 2 via the fastening mechanism 12. The toggles 20,22 are then returned to their first configuration, with the toggles 20,22 in engagement with a lower face of the lower end of the fabric 6 to retain the cords 8,10 within the fabric, and the bottom rail 4 is slid over the bottom end of the fabric 6, thereby retaining the toggles 20,22 in their first configuration and securing the fabric 6.

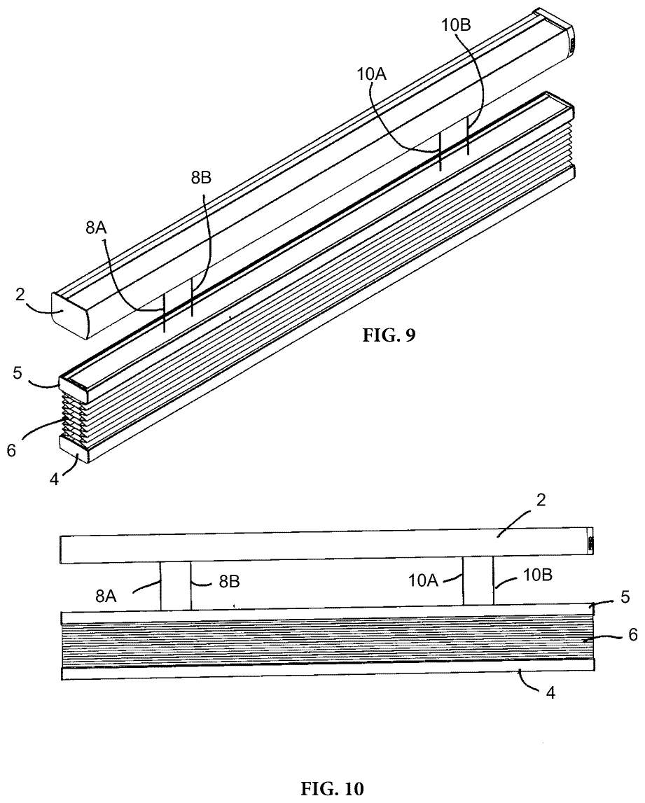

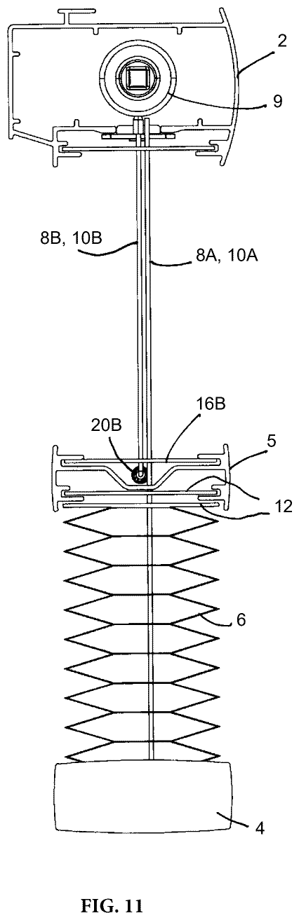

In an alternative embodiment, as shown in FIGS. 9 to 11, rather than being detachably secured to the headrail 2, the upper end of the cellular fabric 6 may be detachably secured to an intermediate rail 5 suspended from the headrail 2 via an additional set of cords 8B,10B. The upper end of the fabric 6 may be detachably secured to the intermediate rail 5 by a releasable fastening mechanism 12, such as one or more magnetic fasteners 12, to permit detachment of the upper end of the cellular fabric 6 from the intermediate rail 5 in a downwards direction, perpendicular to the intermediate rail 5.

As with the first embodiment, in the embodiment shown in FIGS. 9 to 11, the bottom rail 4 can raised and lowered by winding and unwinding the first set of cords 8A,10A, the first set of cords 8A,10A extending from the head rail 2 to the bottom rail 4 and passing through the fabric 6, the cords 8A,10A terminating in toggles (not shown in the drawing but essentially the same as those shown in the first embodiment) located in the bottom rail 4, as with the first embodiment described above. The blind can also be opened from the top by raising and lowering the intermediate rail 5 with respect to the headrail 2 via the additional set of cords 8B,10B. The additional cords 8B,10B may terminate in toggles 20B,22B, similar to toggles 20A,22A, so that the cords 8B,10B can be detached from the intermediate rail 5. The toggles 20B,22B may be retained in their first configuration to prevent removal of the fabric by locating the toggles 20B,22B in a recess 28 in the bottom of a channel 14 provided in an upper face of the intermediate rail, a retainer 16B being slid into the channel 14 to retain the toggles 20B,22B in place in said recess 28.

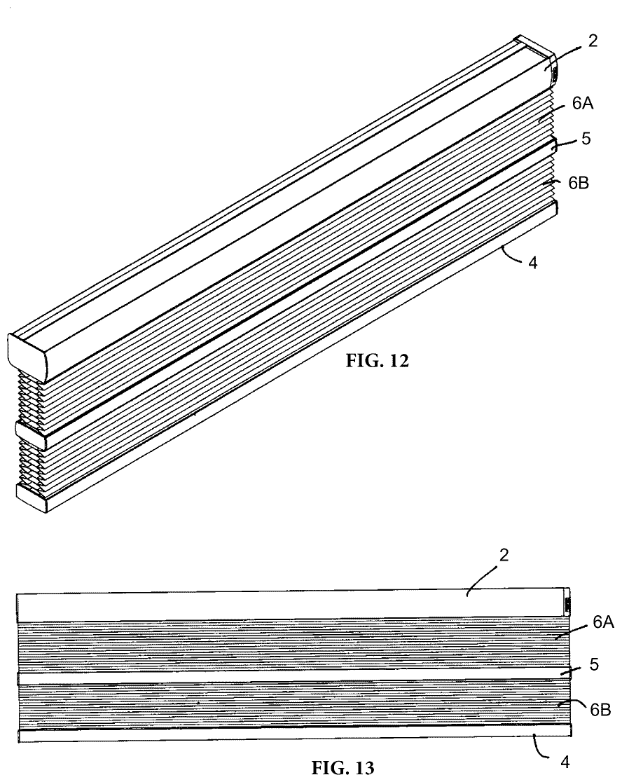

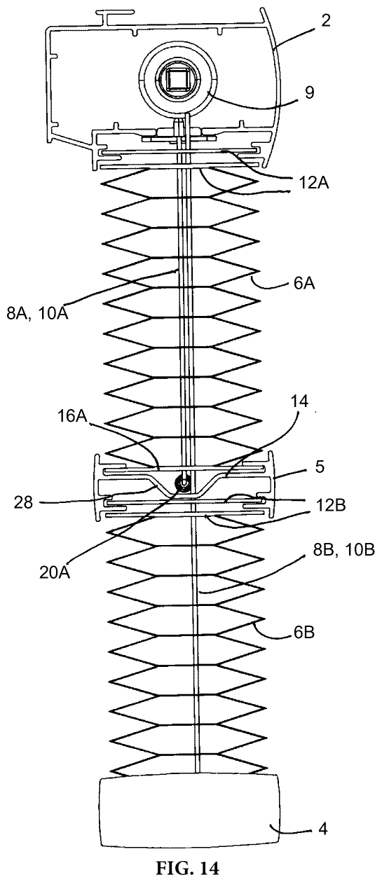

In a third embodiment, illustrated in FIGS. 12 to 14, a first section of fabric 6A may be located between the headrail 2 and an intermediate rail 5 and a second section of fabric 6B may be located between the intermediate rail 5 and the bottom rail 4. Both sections of fabric 6A,6B being replaceable as desired, whereby both the first and second sets of cords 8A,10A,8B,10B pass through the first section of fabric 6A, the first set of cords 8A,10A also passing through the second section of fabric 6B and terminating in toggles 20A,22A located in a recess 28 in a channel 14 in an upper face of the bottom rail 4, as with the first embodiment. The second set of cords 8B,10B pass through just the first section 6A of fabric and terminate in respective toggles 20B,22B selectively retained in a recess 28 in a channel 14 in an upper face of the intermediate rail 5, as with the second embodiment.

The invention is not limited to the embodiment described herein but can be amended or modified without departing from the scope of the present invention as defined by the following claims as interpreted according to the principles of patent law including the doctrine of equivalents.

1. A cellular blind comprising:
a headrail;
a lower rail below said headrail;
one or more lengths of cellular fabric located between the headrail and the lower rail;
a plurality of control cords extending through at least one of said one or more lengths of cellular fabric and terminating in or adjacent said lower rail; and
a toggle at a terminal end of each of said control cords;
wherein said cords are raisable and lowerable via a control mechanism in said headrail to raise or lower said blind;
wherein an upper end of said one or more lengths of cellular fabric is detachably secured respectively to said headrail or said lower rail, to permit replacement of said one or more lengths of cellular fabric; and
wherein said toggles are adapted to prevent removal of said cords from said at least one of said one or more lengths of cellular fabric when said toggles are in a first configuration, while permitting removal of said cords from said one or more lengths of cellular fabric when said toggles are in a second configuration.

2. The blind of claim 1, wherein said lower rail comprises a bottom rail or an intermediate rail that is suspended from said headrail and positioned above a bottom rail.

3. The blind of claim 1, wherein each said toggle is moveable between said first configuration, wherein each said toggle extends substantially perpendicular to the respective cord to operatively retain said cords within said cellular fabric and allow operation of said blind, and said second configuration, wherein each said toggle is axially aligned with the respective cord whereby said toggles can be pushed through said cellular fabric to thread said cords through said cellular fabric or remove said cords from said cellular fabric to facilitate replacement of said cellular fabric.

4. The blind of claim 3, wherein said cords extend from each toggle at a point between a distal end of each said toggle when said toggles are in their first configuration.

5. The blind of claim 4, wherein said cords extend from a central region of each said toggle when said toggles are in their first configuration.

6. The blind of claim 1, wherein said one or more lengths of cellular fabric are attached to said headrail or said lower rail by a releasable fastening mechanism permitting detachment of said cellular fabric therefrom in a downwards direction, perpendicular to said headrail or said lower rail.

7. The blind of claim 6, wherein said releasable fastening mechanism comprises one or more magnetic fasteners.

8. The blind of claim 1, wherein said one or more lengths of cellular fabric are detachably secured at a lower end to said lower rail, said lower rail incorporating a channel in an upper face thereof, said channel receiving a bottom portion of said cellular fabric, whereby said lower rail can be slid on and off said bottom portion of said cellular fabric in a transverse direction to detach and attach said lower rail to said one or more lengths of cellular fabric, wherein said channel includes a recess for housing said toggles when in their first configuration to retain said toggles in said first configuration when said lower rail is attached to said one or more lengths of cellular fabric.

9. The blind of claim 8, wherein said bottom portion of said one or more lengths of cellular fabric received in said channel of said lower rail comprises or incorporates a reinforced strip adapted to be received and retained in said channel.

10. The blind of claim 8, wherein said lower rail comprises a bottom rail or an intermediate rail that is suspended from said headrail and positioned above a bottom rail.

11. The blind of claim 1, further comprising a roller within said headrail, wherein said cords are wrapped around said roller, whereby rotation of said roller raises and lowers said blind.

12. The blind of claim 11, wherein said roller is rotatable by an electric motor.

13. The blind of claim 1, wherein each said toggle comprises an elongate tubular body through which a respective one of said cords is inserted, a distal end of each said cord being knotted or having a fitting attached thereto to prevent removal of the respective cord from said toggle once inserted therein.

14. The blind of claim 13, wherein each toggle has a slot extending along a portion of its length from a first end thereof, said slot terminating at a location between said first end and a midpoint of said toggle, said distal end of the respective cord extending through a second end of said toggle, opposite said first end, wherein said cord rests in said slot when said toggle is in its second configuration and moves out of said slot to extend perpendicular to said body of said toggle when said toggle is in its first configuration.

15. A cellular blind comprising:
a headrail;
a bottom rail;
one or more lengths of cellular fabric located between said headrail and said bottom rail; and
a plurality of control cords extending from said headrail, through at least one of said one or more lengths of cellular fabric, and terminating in or adjacent a lower end of said at least one or said one or more lengths of cellular fabric;
wherein said cords are raisable and lowerable via a control mechanism in said headrail to raise or lower said blind; and
wherein an upper end of said at least one or said one or more lengths of cellular fabric cellular fabric is detachably secured to said headrail, or to an intermediate rail suspended from said headrail by a releasable fastening mechanism permitting detachment of said one or more lengths of cellular fabric therefrom in a downwards direction, perpendicular to the respective rail.

16. The blind of claim 15, wherein said releasable fastening mechanism comprises one or more magnetic fasteners.

17. The blind of claim 15, wherein each cord terminates in a toggle, each toggle being moveable between a first configuration in which said toggle extends substantially perpendicular to the respective cord to operatively retain said cords within at least one of said one or more lengths of cellular fabric and allow operation of said blind, and a second configuration in which said toggle is axially aligned with said respective cord whereby said toggles can be pushed through said cellular fabric to thread said cords therethrough or remove said cords therefrom to facilitate replacement of said cellular fabric.
